(19) United States
(12) Patent Application Publication
(10) Pub. No.: US 2024/0095364 A1
(43) Pub. Date: Mar. 21, 2024

(54) PRIVACY-PRESERVING AND SECURE APPLICATION INSTALL ATTRIBUTION

(71) Applicant: Google LLC, Mountain View, CA (US)

(72) Inventors: Gang Wang, Frederick, MD (US); Nicholas Alexander Bruno Sabatino, San Francisco, CA (US); Alex Daniel Jacobson, Mountain View, CA (US)

(21) Appl. No.: 17/928,714

(22) PCT Filed: May 6, 2022
(86) PCT No.: PCT/US2022/028130

§ 371 Date: Nov. 30, 2022

(51) Int. Cl. G06F 21/57; G06F 8/61; G06F 21/64; H04L 9/32

(52) U.S. Cl. CPC G06F 21/572; G06F 8/61; G06F 21/64; H04L 9/3247; G06F 2221/033

(57) ABSTRACT

Methods, systems, and apparatus, including computer programs encoded on a computer storage medium for securely attributing application (app) installations while preserving user privacy are described. In one aspect, a method includes a given digital component that can be provided and can include a reference to a software application. A user interaction with the digital component that initiates installation of the application can be detected. The software application can be installed at a client device. The following can be obtained: (i) impression data that reference the software application and (ii) interaction data that reference the software application. Attribution credits for the installation of the software application can be assigned by applying an attribution model to the presentation and interaction data. Attribution tokens can be generated that includes (i) data identifying the software application, (ii) data identifying the respective attribution credit assigned to the entity, and (iii) and an integrity token.

### TECHNICAL FIELD

This specification is related to data security and data processing.

### BACKGROUND

The usefulness of computing devices, such as mobile phones, is largely defined by the applications, often called “mobile apps” or “apps,” installed on the devices. Apps can provide functions such as personal productivity, social networking, messaging, e-mail, news, games, among many other categories.

When interacting with a mobile device, users can be provided with digital components that inform the user about the availability of various apps. Such digital components are beneficial to both the user and the app publisher: the user becomes aware of an app that might prove useful, and the app publisher gains user exposure for their app. Third-party digital component providers who supply digital components that provide such information can enhance this synergy.

### SUMMARY

This specification is generally related to systems and techniques for securely attributing application installations while preserving user privacy and resisting malicious activity. Data from multiple app installations can be aggregated and anonymized before the data is reported to attribution apparatuses, providing increased privacy to users who install the apps.

In general, one innovative aspect of the subject matter described in this specification can be embodied in methods including the operations of providing, at a client device, a given digital component comprising a reference to a software application. The client device detects a user interaction with the given digital component that initiates installation of the software application on the client device. The software application is installed at the client device. The following can be obtained: (i) impression data for each of one or more provisions, at the client device, of one or more digital components that reference the software application and (ii) interaction data for each of one or more user interactions with at least one of the one or more digital components that reference the software application, wherein the one or more digital components comprise the given digital component. Respective attribution credits for the installation of the software application are assigned, by applying an attribution model to the presentation data and the interaction data, to one or more entities that provided the one or more digital components. For each entity, an attribution token is generated. The attribution token includes (i) data identifying the software application, (ii) data identifying the respective attribution credit assigned to the entity, and (iii) and an integrity token that verifies that the software application was installed on the client device and that the attribution token was generated by an authentic client device. The attribution token is provided. Other implementations of this aspect include corresponding apparatus, systems, and computer programs, configured to perform the aspects of the methods, encoded on computer storage devices.

These and other implementations can each optionally include one or more of the following features. The attribution token for each entity can include data identifying a particular digital component provided by the entity. The attribution token for each entity can include a digital signature of the data identifying the software application, the data identifying the respective attribution credit assigned to the entity, and the integrity token that verifies that the software application was installed on the client device and that the attribution token was generated by an authentic client device. The attribution token for each entity can include a public key of an application that initiated a request for the digital component provided by the entity, that provided the digital component provided by the entity, and at which a user interacted with the digital component provided by the entity. The user interaction can include displaying the digital component for a specified period of time. The client device can store at least one of the impression data or the interaction data in secure storage of a trusted program running on the client device. For each provision of a digital component, the impression data can be provided for the digital component to the entity that provided the digital component. For each interaction with a digital component, a user interaction token for the digital component can be sent to the entity that provided the given digital component. The attribution token can include one or more of the identity of the software application installed or, an application provider from which the software application was downloaded.

Particular embodiments of the subject matter described in this specification can be implemented so as to realize one or more of the following advantages. The techniques described below can increase resource efficiency by eliminating from the network all attributions and/or event reporting messages that do not relate to an actual app install. Since installations occur relatively infrequently as compared to the display of digital components for the apps, e.g., 1% or less in many cases, the message reduction can be substantial especially when aggregated over millions of client devices and billions of digital component presentations, thereby preserving network bandwidth that would otherwise be wasted. This message reduction reduces consumption of server resources and network bandwidth for digital content platforms, as well as consumption of client device resources, including memory, local storage, bandwidth and battery, on users' mobile devices.

The techniques described below also protect user privacy by preventing the collection of sensitive user data and by preventing user tracking across different applications and across application publishers. In addition, by providing rich metadata relating to impression and digital component interactions in privacy preserving ways, e.g., using aggregation engines, the techniques support proper attribution of component installations without sacrificing the privacy guarantees. In addition, the techniques support detection and/or resistance of malicious activity, e.g., by cryptographically encoding messages that are transmitted among system components and using digital signatures to detect changes to the content of such messages.

The details of one or more implementations of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flow diagram of an example process for app install attribution.

FIG. 2 is a block diagram of an example environment for privacy-preserving app install attribution.

FIG. 3 is a flow diagram of an example process for user impression, digital component interaction, and app interaction attestation.

FIG. 4 is a flow diagram of an example process for impression attestation.

FIG. 5 is a flow diagram of an example process for user component interaction attestation.

FIG. 6 is a flow diagram of an example process for user app installation attestation.

FIG. 7 is a block diagram of an example computer system.

Like reference numbers and designations in the various drawings indicate like elements.

### DETAILED DESCRIPTION

Software applications, such as mobile apps which are also referred to as “apps” for brevity, improve the usefulness of computing devices by enhancing the capabilities of the devices. In fact, apps are sufficiently useful that some contemporary app repositories contain over one million available apps. While the enormous number of available apps provide nearly limitless options for uses, the volume of apps also makes it difficult for users to become aware of apps that might meet a particular need.

To help users find relevant apps, some app publishers provide information about their apps, for example, by embedding information about their app in web content or in other apps. In some cases, app publishers enlist third-party digital component providers, which supply digital components that provide information about one or more applications to enhance this synergy. In fact, users often interact with digital components, e.g., view for at least a specified period time and/or select the digital components, supplied by multiple third parties, some of which might provide information for the same application. This leads to a challenge: when an app is installed, an app publisher may have to determine which third party initiated the install.

To provide such attributions, a system can measure, for example, four events related to an app install: (i) a user makes a request, which can be a direct request for information about an app, or an indirect request in which various signals are used to determine that the request is relevant to the app; (ii) app information is provided to the user, creating an “impression;” (iii) the user interacts with the information, creating a user interaction; and (iv) the user installs and opens the app. However, each event can initiate a separate reporting message, and correlating across these messages may involve providing a common identifier (CID) to be used across all four stages, which can be detrimental to user privacy. For example, the CID can be used to aggregate behaviors of a user across platforms (e.g., across publishers of digital components, content providers, app providers, etc.), potentially providing intrusive insights into the user's behaviors.

Reporting each such event to provide app install attribution is resource-inefficient. As noted above, step (ii) is an indication of an impression—that is, the user received information about an available app. However, only a small percentage of impressions result in app installs—often 1% or less—so the vast majority (99% or more) of messages related to attribution authorities are wasted, reporting impressions that do not actually result in installation. Eliminating such unnecessary messages can result in improved network performance by reducing congestion, while also reducing the load on the devices that create and transmit the messages and the servers that receive and process them.

The techniques described in this document provide accurate and secure attributions of app installs while protecting user privacy and reducing the impact of the attribution process on system resources. Accurate attribution typically involves resiliency against malicious activity in all four steps listed above, and there are opportunities for such activity in each step. For example: (i) an operating system emulator can generate the user request; (ii) a simulated impression can be rendered off-device and never actually visible to the user, or the impression might not relate to a reference to the specific app that was installed on the user's devices; (iii) the user interaction can be generated programmatically; and (iv) the report of the application install can be falsified or otherwise malicious. The systems and techniques provide resiliency against malicious activity across each of these opportunities.

To protect against malicious activity, an attribution provider can measure the four events to determine which third-party should be credited for the install. However, to do so, the attribution providers collect massive amounts of information to facilitate the attribution process. For example, the attribution provider may collect all the information about user requests, impressions and interactions, regardless of whether they lead to an app installation. Along with causing a substantial number of network messages, such information potentially reveals users in-app activity in minute details, threatening user privacy.

In addition, user requests, impressions, and user interactions often occur on apps that differ from the app that was installed—that is, a web page or an app displays a digital component that references a second app that is eventually installed. Therefore, the attribution process can link the users' activities across boundaries, including app boundaries (that is, beyond a single app) and even across app-publisher boundaries (that is, beyond a single app publisher). Such linking can impinge on user privacy and data security, and is forbidden in some circumstances, including when cross-app, cross-publisher (e.g., cross-domain) tracking is banned. The techniques described in this document provide built-in resistance to malicious activity, while still protecting user privacy and data security without collecting such sensitive data and in platforms and/or environments where tracking is banned. Thus, the techniques described in this document can provide secure, accurate, and malicious-activity-resisting attribution even within systems that prevent the collection of such sensitive data.

Further, when cross-app or cross-publisher tracking is banned, the CID might not be available to help attribution providers to form the casualty chain across events (i) to (iv), thereby breaking attribution processes. An attribution provider may attempt to circumvent the prohibition on using CIDs, for example, by joining user activity across apps using forbidden techniques such as user fingerprinting, but, in some cases, such techniques are prohibited by platform policy and relevant regulation, and can be unreliable.

The techniques described in this document provide a solution that addresses the issues related to fraudulent attributions while preserving privacy and network resources. Specifically, the techniques described in this document provide at least the following advantages: (a) detection of and resiliency against malicious activity such that the attribution process is secure; (b) strong privacy protection and data security; (c) a verifiable causality chain to support reporting; and (d) efficient use of system resources.

Some solutions may provide a subset, but not all, of these advantages. For example, a cryptography-based solution may use cryptography to develop a chain of trust and attestation. In such solutions, a digital signature, e.g., generated using the Elliptic Curve Digital Signature Algorithm or another appropriate digital signature technique, can be used to ensure that an event, such as an impression or an interaction actually occurred on a device. The device can affix a digital signature to the event, and other parties can use the digital signature to verify that the event is authentic. A trusted program (described below) can maintain a public key/private key pair, and use the private key to sign tokens associated with events. Such a token allows third parties to confirm that events were signed by the trusted program on the device.

In addition, the trusted program can maintain, for each app publisher, a public key/private key pair (collectively called “key pairs”). Such designs can be called “sharded” as key pairs are separated (sharded) per publisher. For supported events (e.g., a request originating from the app), an app can request a secure token based on the key pair of its publisher. The trusted program can then sign the token using the private key assigned to the publisher. In such designs, the sharded secure events—that is, events having tokens signed with the private key—are separated among publishers, so users cannot be tracked across apps provided by different publishers, thereby improving privacy protections.

Further to the descriptions throughout this document, a user may be provided with controls (e.g., user interface elements with which a user can interact) allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

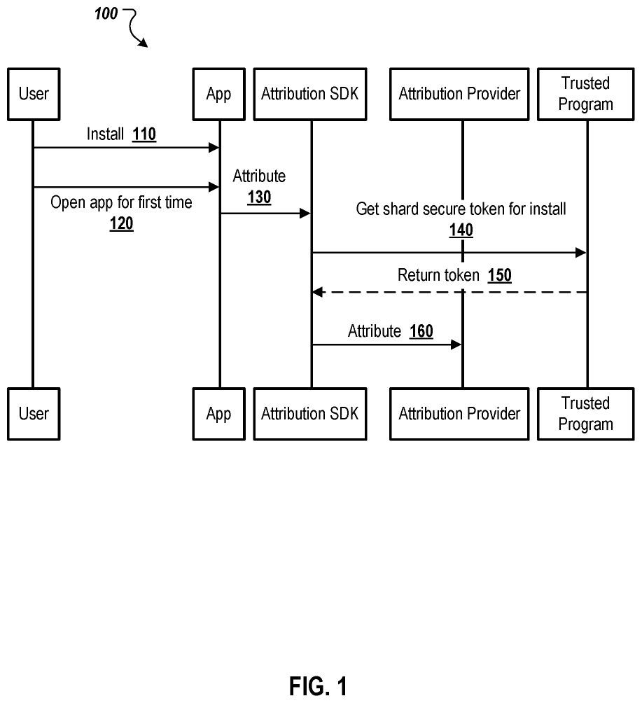

FIG. 1 is a flow diagram of an example process 100 for privacy-preserving app install attribution, as described above. A user installs (110) an app, then opens (120) the app for the first time. The app sends (130) a message to an attribution software development kit (SDK) that exists within the app. The SDK requests (140) a sharded secure token from a trusted program that can exist on the device, and the trusted program responds (150) with the token. The attribution SDK can send (160) an attribution that includes the secure token to an attribution provider. Since the attribution includes the secure token, the attribution provider knows that the installation was authentic.

Although this technique ensures that app install reports are authentic, it fails to meet a verifiable causality chain to support reporting. Specifically, while the secure token can be used to authenticate the install, since secure tokens associated with one publisher cannot be joined with requests, impressions and click events that occur in other publishers' apps and that led to the app install can not be attributed properly. Therefore, the chain is broken. In addition, such solutions do not effectively use system resources since excess messages are transmitted and processed by the various computing systems.

As described further below, this specification describes techniques that provide attribution while satisfying the requirements listed above—that is, detection of and resiliency malicious activity, strong privacy protection, a verifiable causality and efficient use of system resources.

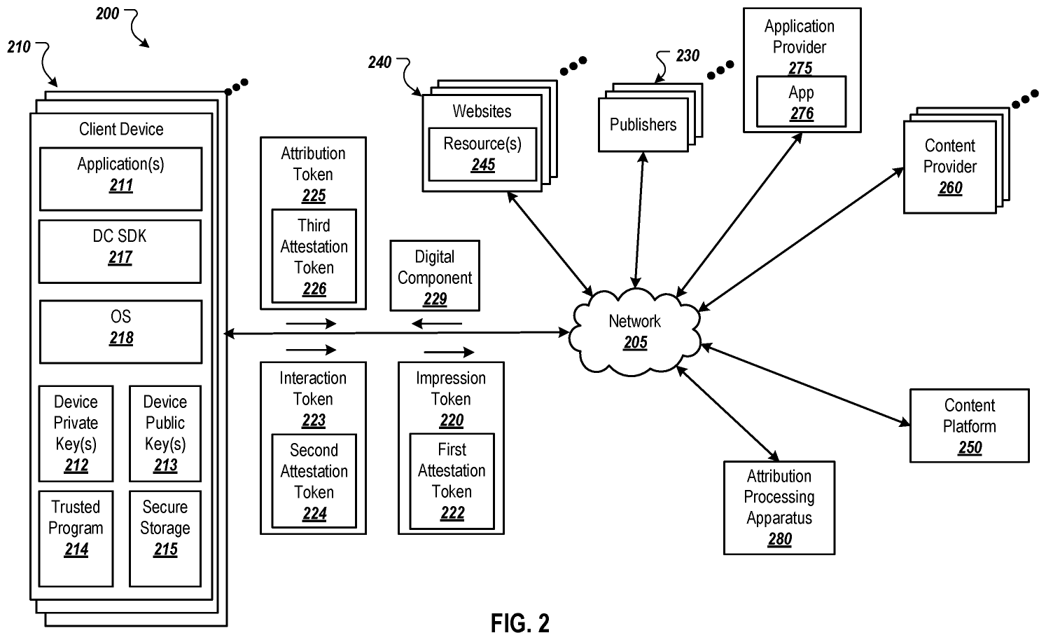

FIG. 2 is a block diagram of an example environment 200 for privacy-preserving app install attribution. The example environment 200 includes a data communication network 205, such as a local area network (LAN), a wide area network (WAN), the Internet, a mobile network, or a combination thereof. The network 205 connects client devices 210, publishers 230, websites 240, content platforms 250, content providers 260, application providers 275, and an attribution processing apparatus 280. The environment 200 can include many client devices 210, publishers 230, websites 240, content platforms 250, content providers 260, application providers 275, and attribution processing apparatuses 280.

A website 240 is one or more resources 245 associated with a domain name and hosted by one or more servers. An example website is a collection of web pages formatted in HTML that can contain text, images, multimedia content, and programming elements, such as scripts. Each website 240 is maintained by a publisher 230, which is an entity that controls, manages and/or owns the website 240.

A resource 245 is any data that can be provided over the network 205. A resource 245 is identified by a resource address, e.g., a Universal Resource Locator (URL) or Uniform Resource Identifier (URI), that is associated with the resource 245. Resources include HTML pages, word processing documents, and portable document format (PDF) documents, images, video, and feed sources, to name only a few. The resources can include content, such as words, phrases, images and sounds, that may include embedded information (such as meta-information in hyperlinks) and/or embedded instructions (such as programs or scripts).

A client device 210 is an electronic device that is capable of communicating over the network 205. Example client devices 210 include personal computers, mobile communication devices, e.g., smart phones, digital media players, smart speakers, and wearable devices (e.g., smart watches), game consoles, streaming devices, and other devices that can send and receive data over the network 205 and on which applications can be installed. A client device 210 can include a display that can be a touch screen display capable of detecting user interactions such as “taps” and “swipes.” The client device 210 can include other input and output mechanisms and/or devices.

The client device 210 includes an operating system (OS) 218, which is software that manages hardware on the client device 210, software application installed on the client device 210, and provides common services for applications. For example, when a user taps on a touch screen display, the OS 218 can relay an event associated with the tap to applications 211 that have registered to receive such events.

The client device 210 can also include a digital component SDK (DC SDK) 217. The DC SDK 217 enables applications on a client device 210 to request and download digital components 229 from content platforms 250, and to notify one or more content platform 250 when an impression (e.g., display of a digital component 229) occurs, when a user interaction (e.g., selection) occurs, and/or when an installation of an app occurs. The DC SDK 217 can include software libraries that can communicate, or enable the client device 210 to communicate, through the network 205 to publishers 230, web sites 240 and content platforms 250. For example, the DC SDK 217 can communicate using HypterText Transfer Protocol (HTTP) or HTTP-Secure (HTTP-S). Messages sent from the DC SDK to other elements in the system can include content (e.g., request strings) and tokens (which can be secure tokens). Messages back to the DC SDK can include content (including digital components 229), secure tokens, etc.

One type of secure token is an attestation token 222, 224, 226. An attestation token is a secure token that contains information for securely conveying evidence that an event occurred. For example, attestation tokens 222, 224, 226 can be used to provide information relating to impressions, user interactions, and installations.

The attestation token 222, 224, 226 is used by entities to validate the integrity of the request and the integrity of the client device 210. For example, enabling users to manage their data that is stored by other entities can open up the possibility of malicious users attempting to manage and/or steal other users' data. For digital components, some malicious entities may attempt to falsify the parameters of digital component requests, e.g., to specify different resources with which the digital component will be provided and/or to specify a different user to which the digital component will be presented to make the request appear more valuable than it actually is. In addition, some malicious parties may attempt to emulate others' client devices for nefarious purposes.

The attestation token 222, 224, 226 provides a secure communication channel between the client device 210 and the computers or other devices of other entities through intermediaries that prevents others from altering messages 220, 223, 225 ensures that the messages 220, 223, 225 came from a validated client device 210. The attestation token 222, 224, 226 includes the set of data and a signature, e.g., a digital signature, generated based on the set of data, e.g., a hash function such as SHA-256. The digital signature can be used to validate the attestation token 222, 224, 226. A component that receives an attestation token can validate the attestation token by verifying the digital signature of the attestation token. For example, the component that receives the attestation token can decrypt the content and computing a signature for the set of data and comparing that signature to the received digital signature. If the signatures match, the attestation token can be determined to be valid, if the signatures do not match, the attestation token can be determined to be invalid.

The set of data can include a public key 213 of the client device 210 sending the request, a token creation time that indicates a time at which the attestation token 222, 224, 226 was created, a payload, and/or a device integrity token. The payload can include impression tokens 220, interaction tokens 223 and attribution tokens 225. In this specification, the combination of an attestation token and the set of data can be referred to as a secure message.

The client device 210 generates and maintains one or more pairs of related cryptographic keys including a private key 212 and a public key 213 that corresponds to, and is mathematically linked to, the private key 212. Data that is digitally signed using the private key 212 can only be verified using the corresponding public key 213. An attestation token 222, 224, 226 that includes a digital signature generated using a private key 212 that corresponds to a public key 213 can only be verified using the corresponding public key 213. Similarly, data that is encrypted using the public key 213 can only be decrypted using the corresponding private key 212.

The application 211 initiating a request (or another application operating on the client device 210) generates a signature of the set of data using the private key 212. In some implementations, the application 211 uses an Elliptic Curve Digital Signature Algorithm (ECDSA) to generate the digital signature, but other signature techniques can also be used, such as RSA. As the attestation token 222, 224, 226 can be sent from a mobile device, signature techniques that result in smaller data sizes may be preferable. The public key 213 is provided with the attestation token 222, 224, 226 so that entities that receive the attestation token 222, 224, 226 can use the public key 213 to verify the signature of the set of data.

The private key 212 and the public key 213 of the client device 210 can be replaced. For example, the keys 212 and 213 can be replaced periodically based on a specified time period to prevent entities from tracking users using the public key 213 included in the attestation token 222, 224, 226. In another example, the user can initiate the key replacement and, in response, a new pair of private and public keys can be generated by the client device 210.

The public key 213 for a client device 210 can serve as a unique device identifier for the client device 110. As described in more detail below, the public key 213 in this role can enable recipients of secure messages to verify that the secure message originated from the client device 210.

As described above, the token creation time indicates a time at which the attestation token 222, 224, 226 was created. The application 211 can record the creation time when the application creates the attestation token. This token creation time can be a high resolution timestamp (e.g., accurate to the second, to the millisecond, or to the microsecond). The token creation time can be used to determine whether a secure message that includes the attestation token 222, 224, 226 is new or recent request. For example, the entity that receives the attestation token 222, 224, 226 can compare the token creation time to a current time or a time at which the attestation token 222, 224, 226 was received. If the difference between the two times exceeds a threshold, the entity can determine that the request is not new, or invalid, as described in more detail below.

The token creation time can also be used to detect replay attacks. For example, if multiple requests having the same set of data, including the same token creation time, are received, the entity that receives the requests can determine that the requests are duplicates and/or that the requests are part of a replay attack.

The token creation time, in combination with other data, can also serve as a transaction identifier for a secure message. For example, the transaction identifier can be a combination of two or more of the token creation time of the attestation token 222, 224, 226 and the public key 213 of the attestation token 222, 224, 226. The transaction identifier can be used to deduplicate multiple versions of the same request received from multiple channels.

The payload can include data for the individual secure message. For example, if the secure message is a request for a digital component, the payload can include data that can be used to select a digital component. This payload could include the resource that has the digital component slot (or a URL for the resource), information about a resource (e.g., topic of the resource), information about the digital component slot (e.g., the number of slots, the type of slots, the size of the slots, etc.), information about the client device 210 (e.g., type of device, geographic location of the client device 210, etc.) if the user has enabled this feature, and/or other appropriate information.

A client device 210 typically includes applications 211, such as a web browser and/or native applications to facilitate the sending and receiving of data over the network 205. A native application is an application developed for a particular platform or a particular device. Publishers can develop and provide, e.g., make available for download, native applications to the client devices 210. A web browser can request a resource from a web server that hosts a website of a publisher, e.g., in response to the user of the client device 210 entering the resource address for the resource in an address bar of the web browser or selecting a link that references the resource address. Similarly, a native application can request application content from a remote server of a publisher.

Some resources 245, application pages, or other application content can include digital component slots for presenting digital components with the resources 245 or application pages. As used throughout this document, the phrase “digital component” refers to a discrete unit of digital content or digital information (e.g., a video clip, audio clip, multimedia clip, image, text, or another unit of content). A digital component 229 can electronically be stored in a physical memory device as a single file or in a collection of files, and digital components can take the form of video files, audio files, multimedia files, image files, or text files and include advertising information, such that an advertisement is a type of digital component. For example, the digital component 229 may be content that is intended to supplement content of a web page, resource, or application page presented by an application 211. More specifically, the digital component 229 may include digital content that is relevant to the resource content (e.g., the digital component may relate to the same topic as the web page content, or to a related topic). The provision of digital components 229 can thus supplement, and generally enhance, the web page content. In some cases, the digital component 229 will pertain to an app 211 that can, when installed, improve the utility of the client device 210.

When the application 211 (also referred to as the first application) loads a resource 245 or application content that includes one or more digital component slots, the application 211 can request a digital component 229 for each slot from the content platform 250. Some publishers 240 use a content platform 250 such as a supply-side platform (SSP) to manage the process of obtaining digital components for digital component slots of its resources and/or applications. An SSP is a technology platform implemented in hardware and/or software that automates the process of obtaining digital components for the resources and/or applications. Each publisher 240 can have a corresponding SSP or multiple SSPs. Multiple publishers 240 may use the same SSP.

The content platform 250 can, in turn, request digital components from content providers 260. The content providers 260 are entities that provide digital components for presentation with resources 245 and/or other content. An example content provider is an organization that publishes an application, e.g., a native application for mobile devices. This content provider may provide digital components that include content related to the application and a link to download the application. The content providers 260 can use content platforms 250 such as a demand-side platform (DSP) to manage the provisioning of its digital components for presentation in digital component slots. A DSP is a technology platform implemented in hardware and/or software that automates the process of distributing digital components for presentation with the resources and/or applications. A DSP can interact with multiple SSPs on behalf of content providers 260 to provide digital components for presentation with the resources and/or applications of multiple different publishers 240. In general, a DSP can receive requests for digital components (e.g., from an SSP), generate (or select) a selection parameter for one or more digital components created by one or more content providers based on the request, and provide data related to the digital component (e.g., the digital component itself) and the selection parameter to an SSP. The SSP can then select a digital component for presentation at a client device 210 and provide, to the client device 210, data that causes the client device 210 to display the digital component.

The content platform 250 can select a digital component for each digital component slot based on various criteria. For example, the content platform 250 can select, from the digital components received from the content providers 260, a digital component based on relatedness to the resource 245 or other application content, performance of the digital component (e.g., a rate at which users interact with the digital component), etc. The content platform 250 can then provide the selected digital component(s) to the client device 210 for presentation with the resource 245 or other application content. The content platform 250 can transmit selected digital components 229 to one or more client devices 210 for presentation by applications 212 operating on the client devices 210.

The client device 210 can also include a trusted program 214 that generates secure tokens for the applications 212. The trusted program 214 can include trusted code from a reliable source that is difficult to falsify or to compromise. For example, the trusted program 214 can be an operating system 210, a portion of an operating system 210, a secure web browser, etc. Generally, the trusted program 214 is difficult to infiltrate, and the amount of time and effort that a perpetrator would need to expend to tamper with the trusted program 214 is prohibitively high. Additionally, because the trusted program 214 is provided and maintained by a reliable source, e.g., an operating system vendor, any vulnerabilities that arise can be addressed by the source. Using such a trusted program 214 in this way provides a technical advantage of increased security at the client device, since the trusted program 214 is difficult to infiltrate. Additionally, the trusted program 214 provides the advantage of mitigating vulnerabilities in the trusted program 214 because the program is maintained by a reliable source.

The trusted program 214 can be local to client device 210. For example, the trusted program 214 can be a device driver of the operating system of client device 210. In some implementations, the trusted program 214 operates entirely locally to client device 210, reducing the need to transmit user information. In some implementations, the trusted program 214 can operate locally to client device 210 and over a network, such as the network 205. For example, the trusted program 214 can be a web browser that is installed on user device 210 and transmits and receives information over the network 205.

The trusted program 214 can generate encryption keys (e.g., public/private key pairs), store encryption keys in secure storage 215 (e.g., a secure cache), store device integrity tokens in secure storage 215, generate secure tokens, generate blind signatures of encryptions keys or derivatives thereof, and/or fetch and store certificates. In some implementations, the trusted program 214 interacts with a device integrity client to send to and receive data from the device integrity system 270 as described below.

To generate secure tokens, e.g., attestation tokens 222, 224, 226, the trusted program 214 of the client device 210 can generate encryption keys such as public/private key pairs. The public/private key pairs can be asymmetric key pairs. Each public/private key pair includes a private key and a public key that correspond to, and is mathematically linked to, the private key. Each generated encryption key can be associated with a particular entity, such as an app publisher, an app, a computing device (including a client device), and so on. The trusted program 214 can store associations between encryption keys and entities in secure storage 215 or in other storage. The secure token can be signed with the private key, which ensures that the party possessing the private key—that is, the client device—is the signer of the secure token.

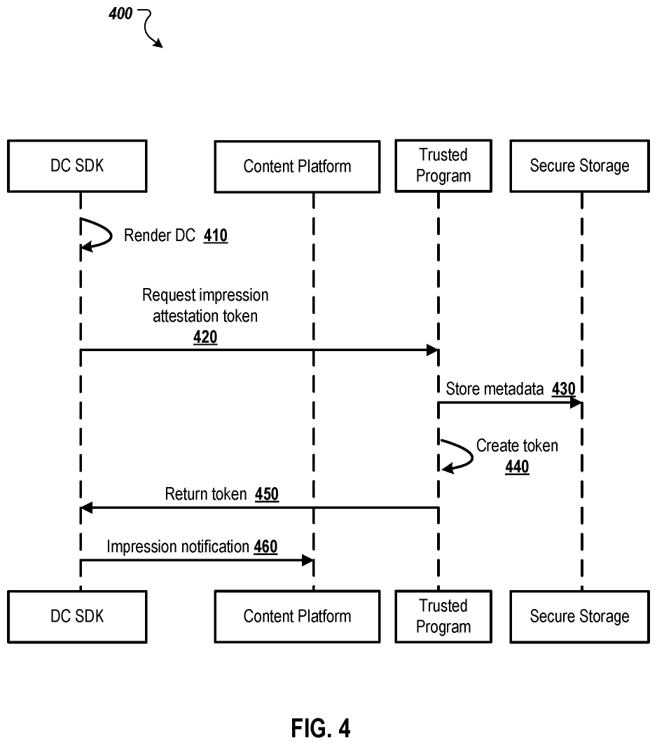

The application 211 on the client device 210 can display the digital component 229 by rendering its content. Rendering content can include displaying images, text, video, etc. on the display of a client device, sending audio data to speakers associated with the device (e.g., speakers that are part of the device or physically connected to the device, or connected by a network link such as Bluetooth to the device), causing the device to vibrate, and so on. Displaying the content corresponds to an impression, described above. After displaying the digital component 229, the client device 210, e.g., the trusted program 214 of the client device 210, can create and store, in secure storage 215, an impression attestation token 220 (or “impression token” for brevity) that includes information relating to the impression of the digital component 229 on the device 210. The impression token 220 can include, or be in the form of, a first attestation token 222. In addition, the client device 210 can transmit the impression token 220 to interested parties. Processing relating to impressions is described further in reference to FIG. 4, below.

Attestation tokens, such as the first attestation token 222, second attestation token 224 and third attestation token 226, provide a secure communication channel between the client device 210 and the computers or other devices of other entities through intermediaries that prevents others from altering the content of messages on the network 205 and ensure they came from a validated client device 210.

For example, the first attestation token 222 can be used by entities such as content providers 260 to validate the integrity of the request and the integrity of the client device 210. For example, some malicious entities may attempt to falsify the parameters of the request for digital components, e.g., to specify different resources with which the digital component will be provided and/or to specify a different user to which the digital component will be presented to make the request appear more valuable than it actually is. In addition, some malicious parties may attempt to emulate others' client devices for nefarious purposes.

When creating the impression token 220, the digital component SDK (DC SDK) 217 can create additional metadata such as an indication of the purpose of the current digital component, e.g., whether it is related to a particular app (e.g., whether the content presented by the digital component is related to the particular app), and if so, an indication of identity of the particular app. The lookback window can be stored by the trusted program 214 and informs the trusted program 214 for how long trusted program 214 should store, e.g., cache, the metadata for attribution purposes. The digital component SDK can store the metadata in secure storage 215. When the lookback window lapses, the digital component SDK can delete the metadata.

In some implementations, the digital component 229 can include content that can reference an app 276 published by the application provider 275. For example, the digital component 229 can be related to a video streaming service. In this example, the digital component 229 can include content identifying an application provider 275 and an application of the video streaming service published by the application provider 275. The user of the client device 210 after being exposed to the digital component 229 presented by the application 211 of the client device 210, may interact with (e.g., pressing a finger and/or a stylus on the touch sensitive screen of the client device 210) the digital component 229.

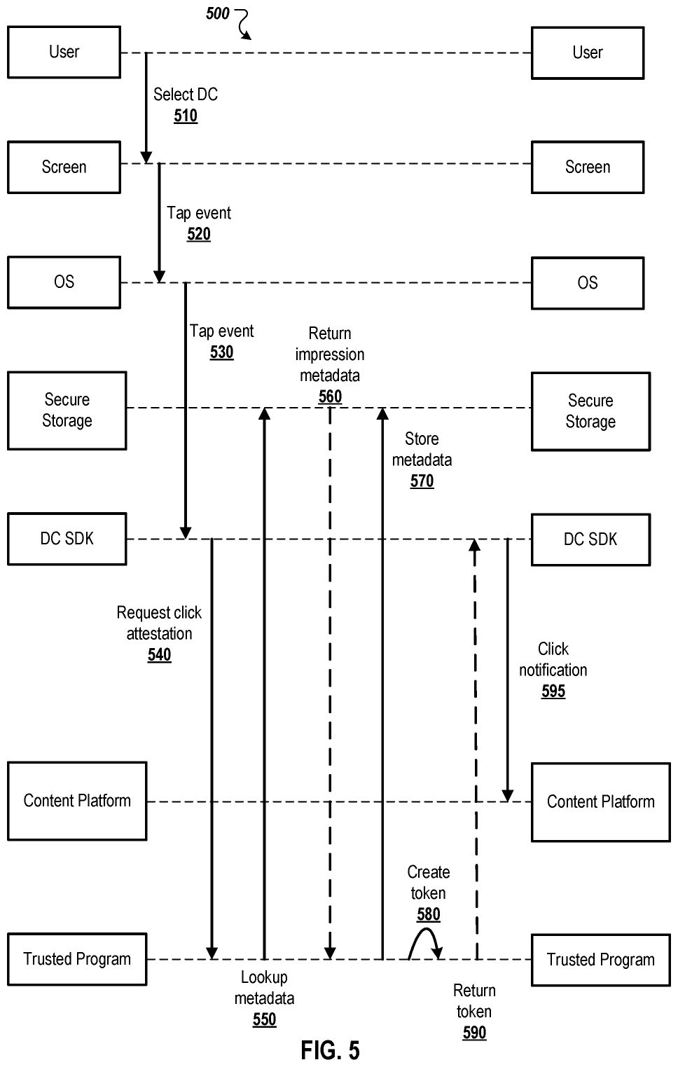

In some implementations, in response to the user interacting with the digital component 229, the client device 210 can create, store (in secure storage 215) and transmit an interaction token 223 that describes the user interaction. The interaction data can include a reference to the digital component 229, a user identifier and other metadata such as the time of interaction, the duration of the interaction, the type of interaction (e.g., press, swipe, etc.) and so on. The interaction token 223 can also include a second attestation token 224. Processing relating to interactions is described further in reference to FIG. 5, below.

In some implementations, in response to the interaction, the user of the client device 210 can be redirected to the application provider 275 via an URL generated by the client device 210 using the content of the digital component 229. The user can then download and/or install the referenced app 276 on the client device 210. For example, the user can download the app of the video streaming service. Once the app has been downloaded, the user can interact with the app, e.g., by installing the app or by installing then opening the app. In some implementations, the client device 210 can store in secure storage 215 an interaction token 225 that describes the app interaction. The interaction token can be stored in response to the client device detecting the installation, the client device detecting the user opening the app, or using other cues.

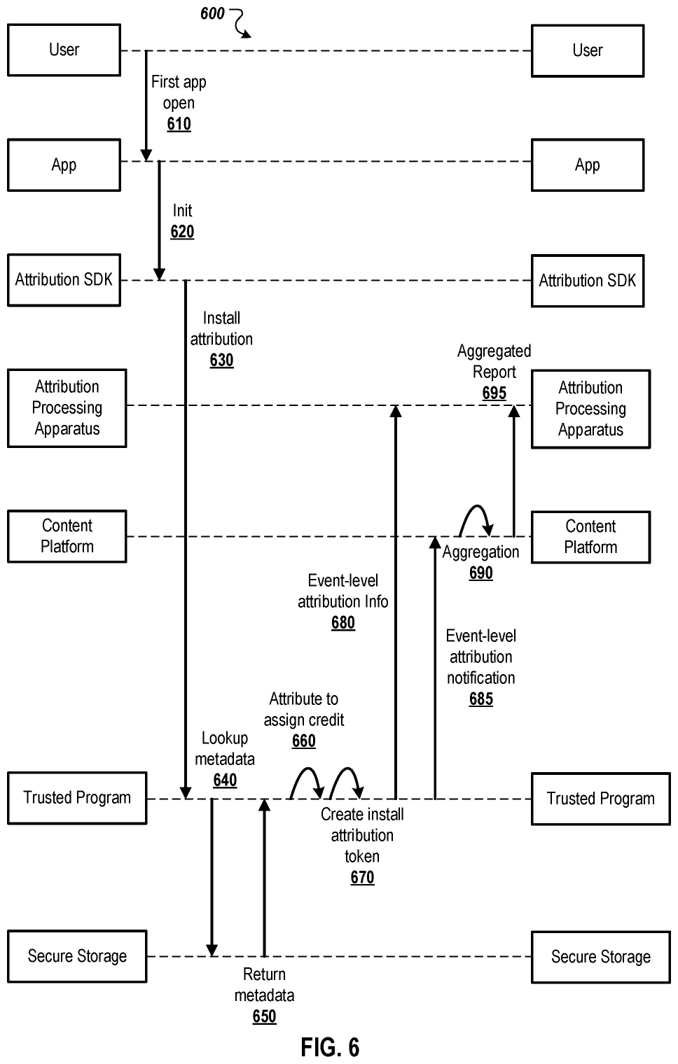

In some implementation, in response to the install, an attribution SDK, which can be a component of a DC SDK 217, can provide the attribution token 225, which can include a third attestation token 226, to an attribution processing apparatus 280. The attribution processing apparatus 280 can be managed by an independent entity and can include a technology platform implemented in hardware and/or software that automates the process of attributing content platforms 250 for providing digital components that result in the download and/or installation of applications. When the attribution processing apparatus 280 receives an attribution token, the attribution processing apparatus 280 can determine, store, and/or distribute the attributions for each content platform 250. The attribution can be in the form of a credit to the content platform 250, e.g., a monetary or non-monetary credit. Processing relating to installation is described further in reference to FIG. 6, below.

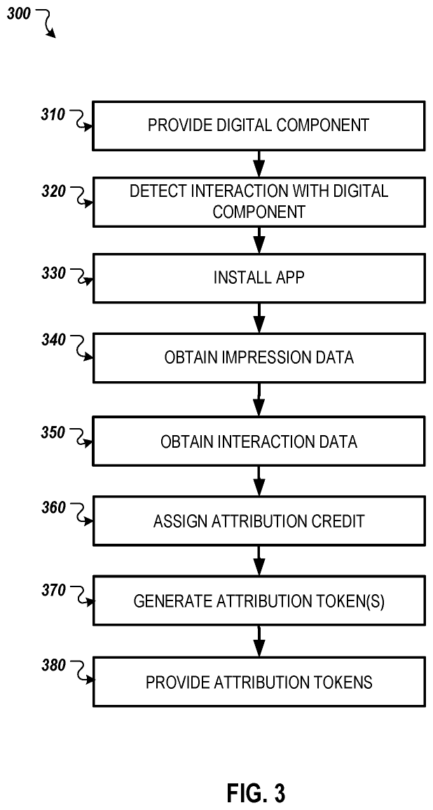

FIG. 3 is a flow diagram of an example process 300 for generating and providing attribution tokens for app installations. For convenience, the process 300 will be described as being performed by a system for privacy-preserving app install attribution, appropriately programmed to perform the process 300. For example, operations of the process 300 can be performed by a client device, e.g., the client device 210 of FIG. 2, and the operations can be performed in collaboration with other components of the environment 200. Operations of the process 300 can also be implemented as instructions stored on one or more computer readable media which may be non-transitory, and execution of the instructions by one or more data processing apparatus can cause the one or more data processing apparatus to perform the operations of the process 300. One or more other components described herein can perform the operations of the process 300.

The system provides (310), e.g., displays, at a client device, a given digital component that includes a reference to a software application, which is also referred to as an app, as noted above. The digital component can be delivered to the client device by a content provider in response to a request from the client device. In some cases, the client device can directly request a digital component by sending a request (e.g., over HTTP or HTTPS) to the content provider. In some cases, the client device can send a request to a web server, and the web server can retrieve the digital component from a content provider and provide the digital component to the client device. In some cases, the client device can send a request to a web server, and the web server can redirect the client device to a content provider hosting the digital component (e.g., using HTTP redirect), and the content provider can send the digital component to the client device.

The reference to the app can include content related to the app. The reference to the app can also include data that initiates the installation of the app in response to the user interacting with the app. For example, the reference to the app can include a link to an app repository of the client device 210 that enables the client device 210 to download apps to the client device 210. In another example, the reference to the app can include a link to a network location, e.g., to a network server of an application provider 265 from which the app can be downloaded.

The system can provide the digital component by activating an application on the client device configured to display the digital component. For example, if the digital component is encoded as Hypertext Markup Language (HTML), the system can activate a web browser on the client device, and cause the web browser to display the digital component.

In response to displaying the digital component, the system can also store on the client device, e.g., in secure storage (as described with reference to FIG. 2) on the client device, a reference to the digital component, and associations between the digital component and each software application referenced by the digital component. For example, the system can store the data in a table where each row in the table includes a reference to the digital component and a reference to a software application referenced by the digital component. The system can also store additional data such as an indicator of the content provider that provided the digital component, the application provider that provides the application, an identifier of the user to whom the digital component was displayed, and so on.

The system detects (320) a user interaction with the digital component that initiates installation of the app on the user device. The system can detect the user interaction by monitoring events provided by an operating system running on the device. In some implementations, the system can register interest in events (e.g., installation or opening) related to interaction with the digital component. In response to receiving an event related to an interaction with the digital component, the system can determine whether the event initiates installation of the app. For example, if the digital component includes an “install” user interface button, and the system receives an interaction indicating that the install button was selected, the system can determine that the installation will begin on the client device and produce an event reflecting the install.

In some implementations, detecting a user interaction can include determining that the digital component has been viewed. For example, if the system detects that a digital component has been displayed on a client device for at least a specified period of time, the system can determine that a user interaction has occurred. In another example, if the system detects that a digital component has been visible within a viewport of the client device for the specified period of time, the system can determine that a user interaction has occurred.

The system can store in storage (e.g., in secure storage as described with reference to FIG. 2) on the client device an indication of the interaction. For example, the system can store the data in a table where each row in the table includes a reference to the digital component and a reference to the user who interacted with the digital component. The system can also store additional data such as a time stamp for the interaction.

The system installs (330), at the client device, the app. In some implementations, when the system determines that an install button was interacted with, e.g., pressed (as described above), the system can cause the operating system to install the application referenced by the digital component by calling an API provided by the operating system that notifies the operating system that an application should be installed. The system can store a record of the install, e.g., in secure storage (e.g., as described with reference to FIG. 2) on the client device.

The system obtains (340) impression data for each of one or more impressions, at the client device, of one or more digital components that reference the app. The system can obtain the impression data by retrieving the data from storage (e.g., secure storage as described with reference to FIG. 2). As described in reference to operation 310, a table in storage can store associations between digital components and applications. The system can inspect the table to determine which digital components were displayed at the client device and that references the app.

The system obtains (350) interaction data for each of one or more user interactions with at least one of the one or more digital components that reference the app. For example, multiple digital components that each reference the app may be displayed to the user of the client device. In some cases, multiple entities, e.g., multiple content platforms, may provide to the same client device digital components that reference the same app.

The system can obtain the interaction data by retrieving the data from storage. From operation 340, the system can obtain the digital component references, and as described in reference to operation 320, a table in storage can store associations between digital component references and interactions. The system can inspect the table using the digital component references to determine the interaction data for the digital component.

The system assigns (360) respective attribution credit for the installation of the app to one or more entities that provided the one or more digital components. The system can apply an attribution model to the impression attestation token and the interaction data, and use the model to determine the respective attribution credits for the installation of the app to one or more entities, e.g., content platform(s), that provided the one or more digital components.

The system can use one or more of various attribution models. In some implementations, the system can include a model that ascribes the entire attribution for the installation of the app to the entity that provided the digital component that references the app with the most recent user interaction. In some implementations, the system can include a model that ascribes an equal attribution level to the provider of each digital component with which there was an interaction and that references the application. In some implementations, the system can include a model that ascribes an equal attribution level to the provider of each digital component that references the application and that was presented by the client device. In some implementations, the system can include a model that ascribes attribution credit to the provider of each digital component with which there was an interaction and that references the application, where credit is ascribed in proportion to the level of interaction (e.g., the number of clicks). In some implementations, the system can include a model that ascribes an attribution level to the provider of each digital component with which there was an interaction and that references the application in proportion to the recency of interaction, e.g., with more recent interactions receiving more attribution credit, and credit decreasing linearly with the time since the interaction. Other attribution models can be included instead or in addition.

The system generates (370) an attribution token that can include payload data that includes (i) data identifying the app, (ii) data identifying the entity to receive attribution credit, (iii) data identifying the respective attribution credit assigned to the entity, and (iv) an integrity token that verifies that the app was installed on the client device and that the attestation token was generated by an authentic client device. As described above, the attribution token can also include a timestamp that indicates a time at which the attribution token is created, a public key of the client device, and a digital signature of the other data of the attribution token (e.g., the timestamp, public key, and payload data).

The integrity token can be provided to the client device by a trusted evaluator that evaluates fraud signals received from the client device to determine whether the client device is an authentic client device, e.g., rather than an emulator. If the evaluator deems the client device to be authentic, the evaluator can provide an integrity token to the client device to include in communications, e.g., in communications that include an attestation token.

The integrity token can include similar data as an attestation token. For example, an integrity token can include a timestamp that indicates when the integrity token was generated, a public key of the trusted evaluator, payload data indicating a verdict of trustworthiness of the client device, and a digital signature generated using the other data (e.g., the timestamp, public key, and payload data). The digital signature can be generated using a private key of the trusted evaluator. In this way, a recipient of the attribution token can verify the integrity token in a similar manner as an attestation token to validate that the client device is a trustworthy device. For example, the recipient can verify the digital signature using the public key included in the integrity token to ensure the other data was not modified after the integrity token was generated, verify the timestamp indicates a recent time (e.g., within a threshold duration of a current time), and verify that the verdict indicates that the client device is trustworthy. If any verification check fails, the recipient may consider the client device untrustworthy and determine to not provide the attributions.

The system provides (380) the attribution token to one or more recipients. The system can provide the attribution token by transmitting a message over the network addressed to one or more attribution targets. The attribution target can be one or more of an attribution processing apparatus, a content provider, a publisher, an application provider or other parties. The system can provide the attribution token using any appropriate networking protocol, such as HTTP or HTTPs.

Each recipient of an attribution token can verify the attribution token, e.g. before taking any action based on the attribution token. This verification can include several verification checks. For example, one verification check can include verifying that the timestamp of the attribution token is within a threshold period of time of a current time. Another verification check can include verifying the digital signature of the attribution token using the public key included in the attribution token. This ensures that the content of the attribution token was not modified after creation. Another verification check can include verifying the integrity token, as described above. If all checks are verified successfully, the recipient can determine that the attribution information is authentic and perform one or more actions based on the attribution information.

For example, if the recipient is an attribution processing apparatus 280 that determines aggregate measurements based on the attribution information, the attribution processing apparatus 280 can determine to use the attribution information in determining the aggregate measurements. If the attribution processing apparatus 280 provides the attribution credits to the content platforms 250 based on the aggregate measurements, the attribution processing apparatus 280 can trust that the attribution information is authentic when the attribution token is verified successfully and provide such credits.

If the attribution token is not verified successfully, the recipient can ignore the attribution information and/or perform other actions. For example, the recipient can alert an attribution processing authority of the potentially malicious attribution token.

FIG. 4 is a flow diagram of an example process 400 for impression attestation. For convenience, the process 400 will be described as being performed by a system for privacy-preserving app install attribution, e.g., components of the environment 200 of FIG. 2, appropriately programmed to perform the process. Operations of the process 400 can also be implemented as instructions stored on one or more computer readable media which may be non-transitory, and execution of the instructions by one or more data processing apparatus can cause the one or more data processing apparatus to perform the operations of the process 400. One or more other components described herein can perform the operations of the process 400.

When an application directs the DC SDK to render a DC (410), the DC SDK requests (420) that the trusted program create an impression attestation token. The request can include metadata such as the purpose of the DC (e.g., to provide information about a referenced app), an identifier for a referenced application (e.g., a video player app), and an attribution lookback window applicable to the current digital component. The lookback window directs the trusted program to cache the impression metadata for a specified duration. In some implementations, if a lookback window is not specified, the trusted program can cache the impression metadata for a configured time period. Upon receiving the request, the DC SDK can also store (430) the metadata in secure storage.

The trusted program can create (440) an impression attestation token and return (450) the token to the DC SDK. The trusted program can also store the impression attestation token in secure storage (as described with reference to FIG. 2). The DC SDK can then transmit (460) the impression attestation token to the content platform.

The impressions attestation token can include, for example, a timestamp that indicates when the impressions token is created, a public key of the client device, payload data (e.g., data related to the impression such at the time of the impression, data identifying the displayed digital component, how long the digital component was displayed, what application or webpage included the digital component, etc.), and a digital signature. The digital signature can be generated by signing over the other data of the impression attestation token (e.g., the timestamp, the public key, and the payload data) using a private key of the client device.

FIG. 5 is a flow diagram of an example process 500 for user component interaction attestation. (For brevity, “user component interaction attestation” can be called “click attestation,” which can indicate that a user interacted with a digital component, e.g., but clicking on or otherwise selecting the component.) For convenience, the process 500 will be described as being performed by a system for privacy-preserving app install attribution, e.g., components of the environment 200 for privacy-preserving app install attribution of FIG. 2, appropriately programmed to perform the process. Operations of the process 500 can also be implemented as instructions stored on one or more computer readable media which may be non-transitory, and execution of the instructions by one or more data processing apparatus can cause the one or more data processing apparatus to perform the operations of the process 500. One or more other components described herein can perform the operations of the process 500.

When a user selects a digital component (510), e.g., by tapping on a touch screen within the boundaries of the displayed area of the digital component, the screen component of the client device can create and deliver (520) a tap event to the OS.

The OS can then transmit (530) the tap event to the DC SDK. In response, the attribution SDK component of the DC SDK requests (540) that that trusted program perform the attribution using the selected attribution model, e.g., the attribution models described in reference to FIG. 3. The attribution SDK can select and specify an attribution model and associated parameters (e.g., the length of time over which to measure attribution credit) on behalf of the attribution provider, who was contracted by the app publisher to perform the attribution.

The trusted program can request (550) the relevant metadata, for example, the metadata stored in operation 330 of FIG. 3, and the secure storage (as described with reference to FIG. 2) can return (560) the metadata. The secure storage can retrieve the metadata by matching stored elements of the metadata (e.g., the identifier for a referenced application) to corresponding metadata provided by the DC SDK. In addition, the DC SDK can process the metadata based on the attribution model and applicable parameters specified, then assign credit to applicable impressions and clicks accordingly. For example, if the click attestation model assigns credit evenly among impressions that occur over the past three days, and there were two impressions over that time period, the DC SDK can assign credit evenly to the content platforms responsible for the two impressions. (Attribution models were described further in reference to FIG. 3.) The trusted program can store (570) the metadata associated with clicks and impressions in secure storage (e.g., as described with reference to FIG. 2).

The trusted program can create (580) an interaction attestation token and return (590) the interaction attestation token to the DC SDK. The DC SDK can provide (595) the click attestation, including the interaction attestation token, to the content provider, for example, by transmitting the interaction attestation token over the network using a suitable networking protocol such as HTTP or HTTPS.

The interaction attestation token can include, for example, a timestamp that indicates when the interaction attestation token is created, a public key of the client device, payload data (e.g., data related to the user interaction such at the time at which the interaction occurred, data identifying the digital component interacted with, what application or webpage included the digital component, etc.), and a digital signature. The digital signature can be generated by signing over the other data of the interaction attestation token (e.g., the timestamp, the public key, and the payload data) using a private key of the client device.

FIG. 6 is a flow diagram of an example process 600 for user app installation attestation. For convenience, the process 600 will be described as being performed by a system for privacy-preserving app install attribution, e.g., components of the environment 200 of FIG. 2, appropriately programmed to perform the process 600. Operations of the process 600 can also be implemented as instructions stored on one or more computer readable media which may be non-transitory, and execution of the instructions by one or more data processing apparatus can cause the one or more data processing apparatus to perform the operations of the process 600. One or more other components described herein can perform the operations of the process 600. As noted above, a user app interaction can be the installation of an app, or an interaction with the app, such as opening the app for the first time.

The user interacts (610) with the app. As described above, types of interaction can include installing or opening the app. Installation of the app can be determined, for example, by receiving an event from the operating system on the user's client device that indicates app install. Opening the app can be determined using various approaches, including receiving an event from the operating system on the user's client device that indicates an app has opened and/or receiving an event from the app indicating that the app has opened. In response to determining that the user has interacted with the app, the application sends (620) an initialization message to the DC SDK. The message can be, for example, a call to an API provided by the DC SDK that indicates to the DC SDK that an interaction has occurred. The initialization message can include an indication of a selected attribution model.

The DC SDK requests (630) that the trusted program perform the attribution using the selected attribution model, e.g., last click attribution. As described above, the trusted program can support a wide variety of predefined attribution models, and if no attribution model is indicated, the trusted program can use an attribution model that has been configured to be a default model.

The trusted program requests (640) the metadata associated with previous impressions from secure storage, and secure storage responds (650) with the requested metadata. Storing and retrieving metadata was described in reference to FIG. 3.

The trusted program processes (660) the metadata based on the attribution model and applicable parameters specified, then assigns credit to applicable impressions and clicks accordingly. For example, if the attribution model uses only the most recent impression, then the trusted program processes only the most recent attribution data stored in secure storage (e.g., as described with reference to FIG. 2). In another example, if the attribution model uses all impressions that occur during a configured period, then the trusted program processes all attribution data stored in secure storage related to those impressions.

The trusted program creates (670) an install token and provides (680) event-level attribution information, which can include an install token, to an attribution apparatus. As described above, the install token can include a secure token to communicate the attribution results securely and verifiably across the network. In some implementations, when installation credit is assigned to multiple content platforms, the trusted program can create and provide event-level attribution information for each credited content platform.

In some implementations, the trusted program can optionally provide (685) an event-level attribution notification, which can include install tokens, to a content platform. The content platform can create (690) aggregate measurements from the received attribution tokens. For example, if a content provider has received attribution credit related to multiple digital component impressions, the content provider can aggregate and report those statistics. In some implementations, the aggregated statistics do not include an indicator of the user of the client device, preserving the user's privacy.

In some implementations, the trusted program encrypts the event level attribution such that only the attribution processing apparatus may decrypt it. For example, the trusted program can encrypt the data using a public key of the attribution processing apparatus, and attribution processing apparatus, and only attribution processing apparatus, can decrypt the data.

The aggregation engine can provide (695) the aggregated measurements to an attribution processing apparatus. To resist attribution fraud attempts from compromised or emulated client devices, before applying aggregation to generate aggregation reports, the attribution processing apparatus can validate the received attribution tokens in individual attribution reports before applying aggregation to generate aggregation reports, for example, by validating the attestation tokens associated with the report. This process ensures that the app installation event occurred on, and the attribution attestation token was generated by an uncompromised device.

The aggregated measurements can include, for each content platform, aggregated attributions across multiple client devices for that content platform, e.g., for each digital component provided by the content platform. For example, if a content platform distributes a particular digital component to multiple client devices and it leads to installation of an application referenced by the digital component at multiple client devices, the content platform may be attributed credit for each installation. The aggregate measurement for this content platform can include the attribution credits aggregated for the multiple installations.

In some implementations, the aggregated measurements can include metadata related to the app installation, such as the identity of the app installed, the app store from which the app was downloaded (or side-loaded), the download timestamp, the installation timestamp, etc. To preserve privacy, the timestamps can be created using a coarse clock, for example, one that reports only the date and hour of an event (download or install).

In some implementations, the aggregated measurements can include metadata related to the digital component request, the impression and the click event. For example, the metadata can include a timestamp of the digital component request, impression and click event and the corresponding digital component request, impression identifier. In addition, the metadata can include the attribution result for the impression and click event.

To further improve privacy protection, the trusted program can add noise (that is, random information) to the transmitted information. The trusted program can also insert random or pseudo-random delays before transmitting the information and the trusted program can use one or more proxy servers (e.g., the Tor network) to mask the IP address of the client device.

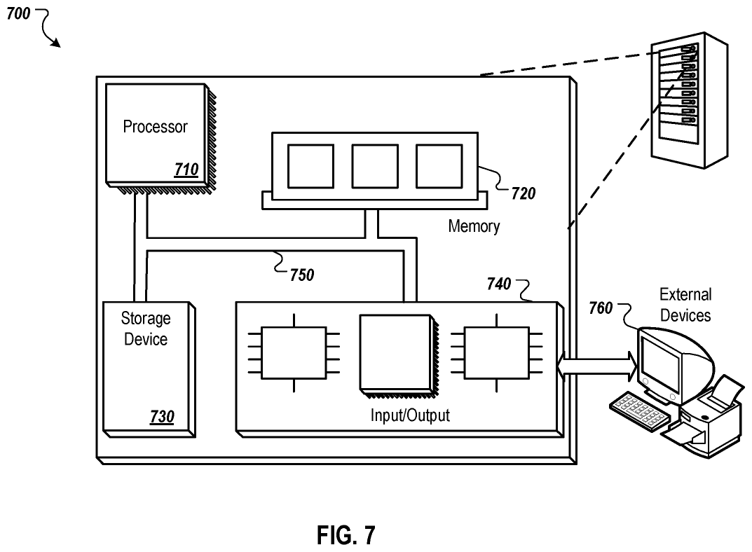

FIG. 7 is a block diagram of an example computer system 700 that can be used to perform operations described above. The system 700 includes a processor 710, a memory 720, a storage device 730, and an input/output device 740. Each of the components 710, 720, 730, and 740 can be interconnected, for example, using a system bus 750. The processor 710 is capable of processing instructions for execution within the system 700. In one implementation, the processor 710 is a single-threaded processor. In another implementation, the processor 710 is a multi-threaded processor. The processor 710 is capable of processing instructions stored in the memory 720 or on the storage device 730.

The memory 720 stores information within the system 700. In one implementation, the memory 720 is a computer-readable medium. In one implementation, the memory 720 is a volatile memory unit. In another implementation, the memory 720 is a non-volatile memory unit.

The storage device 730 is capable of providing mass storage for the system 700. In one implementation, the storage device 730 is a computer-readable medium. In various different implementations, the storage device 730 can include, for example, a hard disk device, an optical disk device, a storage device that is shared over a network by multiple computing devices (e.g., a cloud storage device), or some other large capacity storage device.

The input/output device 740 provides input/output operations for the system 700. In one implementation, the input/output device 740 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 760. Other implementations, however, can also be used, such as mobile computing devices, mobile communication devices, set-top box television client devices, etc.

Although an example processing system has been described in FIG. 7, implementations of the subject matter and the functional operations described in this specification can be implemented in other types of digital electronic circuitry, or in computer software, firmware, or hardware, including the structures disclosed in this specification and their structural equivalents, or in combinations of one or more of them.

An electronic document (which for brevity will simply be referred to as a document) does not necessarily correspond to a file. A document may be stored in a portion of a file that holds other documents, in a single file dedicated to the document in question, or in multiple coordinated files.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework, a Microsoft Cognitive Toolkit framework, an Apache Singa framework, or an Apache MXNet framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
providing, at a client device, a given digital component comprising a reference to a software application;
detecting, at the client device, a user interaction with the given digital component that initiates installation of the software application on the client device;
installing, at the client device, the software application;
obtaining (i) impression data for each of one or more provisions, at the client device, of one or more digital components that reference the software application and (ii) interaction data for each of one or more user interactions with at least one of the one or more digital components that reference the software application, wherein the one or more digital components comprise the given digital component;
assigning, by applying an attribution model to the presentation data and the interaction data, respective attribution credits for the installation of the software application to one or more entities that provided the one or more digital components;
for each entity,
generating an attribution token comprising,
(i) data identifying the software application,
(ii) data identifying the respective attribution credit assigned to the entity, and
(iii) an integrity token that verifies that the software application was installed on the client device and that the attribution token was generated by an authentic client device; and
providing the attribution token to one or more recipients.

2. The computer-implemented method of claim 1, wherein the attribution token for each entity includes data identifying a particular digital component provided by the entity.

3. The computer-implemented method of claim 1, wherein the attribution token for each entity comprises a digital signature of the data identifying the software application, the data identifying the respective attribution credit assigned to the entity, and the integrity token that verifies that the software application was installed on the client device and that the attribution token was generated by an authentic client device.

4. The computer-implemented method of claim 1, wherein the attribution token for each entity comprises a public key of an application that initiated a request for the digital component provided by the entity, that provided the digital component provided by the entity, and at which a user interacted with the digital component provided by the entity.

5. The computer-implemented method of claim 1, wherein at least one of the one or more user interactions comprises displaying a given digital component for at least a specified period of time.

6. The computer-implemented method of claim 1, further comprising:
storing, by the client device, at least one of the impression data or the interaction data in secure storage of a trusted program running on the client device.

7. The computer-implemented method of claim 1, further comprising, for each provision of a digital component, providing the impression data for the digital component to the entity that provided the digital component.

8. The computer-implemented method of claim 1, further comprising, for each interaction with a digital component, a user interaction token for the digital component is sent to the entity that provided the given digital component.

9. The computer-implemented method of claim 1, wherein the attribution token comprises one or more of the identity of the software application installed or, an application provider from which the software application was downloaded.

10. A system comprising:
one or more processors; and
one or more storage devices storing instructions that, when executed by the one or more processors, cause the one or more processors to perform operations comprising:
providing, at a client device, a given digital component comprising a reference to a software application;
detecting, at the client device, a user interaction with the given digital component that initiates installation of the software application on the client device:
installing, at the client device, the software application;
obtaining (i) impression data for each of one or more provisions, at the client device, of one or more digital components that reference the software application and (ii) interaction data for each of one or more user interactions with at least one of the one or more digital components that reference the software application, wherein the one or more digital components comprise the given digital component;
assigning, by applying an attribution model to the presentation data and the interaction data, respective attribution credits for the installation of the software application to one or more entities that provided the one or more digital components;
for each entity,
generating an attribution token comprising,
(i) data identifying the software application,
(ii) data identifying the respective attribution credit assigned to the entity, and
(iii) an integrity token that verifies that the software application was installed on the client device and that the attribution token was generated by an authentic client device; and
providing the attribution token to one or more recipients.

11. (canceled)

12. (canceled)

13. The system of claim 10, wherein the attribution token for each entity includes data identifying a particular digital component provided by the entity.

14. The system of claim 10, wherein the attribution token for each entity comprises a digital signature of the data identifying the software application, the data identifying the respective attribution credit assigned to the entity, and the integrity token that verifies that the software application was installed on the client device and that the attribution token was generated by an authentic client device.

15. The system of claim 10, wherein the attribution token for each entity comprises a public key of an application that initiated a request for the digital component provided by the entity, that provided the digital component provided by the entity, and at which a user interacted with the digital component provided by the entity.

16. The system of claim 10, wherein at least one of the one or more user interactions comprises displaying a given digital component for at least a specified period of time.

17. The system of claim 10, wherein the operations comprise:
storing, by the client device, at least one of the impression data or the interaction data in secure storage of a trusted program running on the client device.

18. The system of claim 10, wherein the operations comprise, for each provision of a digital component, providing the impression data for the digital component to the entity that provided the digital component.

19. The system of claim 10, wherein the operations comprise, for each interaction with a digital component, a user interaction token for the digital component is sent to the entity that provided the given digital component.

20. The system of claim 10, wherein the attribution token comprises one or more of the identity of the software application installed or, an application provider from which the software application was downloaded.

21. A non-transitory computer readable medium storing instructions that, when executed by one or more processors, cause the one or more processors to perform operations comprising:
providing, at a client device, a given digital component comprising a reference to a software application;
detecting, at the client device, a user interaction with the given digital component that initiates installation of the software application on the client device;
installing, at the client device, the software application;
obtaining (i) impression data for each of one or more provisions, at the client device, of one or more digital components that reference the software application and (ii) interaction data for each of one or more user interactions with at least one of the one or more digital components that reference the software application, wherein the one or more digital components comprise the given digital component;
assigning, by applying an attribution model to the presentation data and the interaction data, respective attribution credits for the installation of the software application to one or more entities that provided the one or more digital components;
for each entity,
generating an attribution token comprising,
(i) data identifying the software application,
(ii) data identifying the respective attribution credit assigned to the entity, and
(iii) an integrity token that verifies that the software application was installed on the client device and that the attribution token was generated by an authentic client device; and
providing the attribution token to one or more recipients.

22. The non-transitory computer readable medium of claim 21, wherein the attribution token for each entity includes data identifying a particular digital component provided by the entity.
